(19) United States
(12) Patent Application Publication
(10) Pub. No.: US 2002/0047672 A1
(43) Pub. Date: Apr. 25, 2002

(54) Electron gun in cathode-ray tube

(76) Inventors: Masahiko Mizuki, Kanagawa (JP); Yasunobu Amano, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/931,578

(22) Filed: Aug. 17, 2001

(30) Foreign Application Priority Data
Aug. 22, 2000 (JP) P2000-251237

(51) Int. Cl. G09G 1/28

(52) U.S. Cl. 315/411; 315/368.28

(57) ABSTRACT

An electron gun according to the present invention is provided with a grid having a beam aperture with a small diameter. In addition, the electron gun of the present invention is such that a second grid thereof is comprised of a plurality of grid plates each having the beam aperture. The electron gun of the present invention is such that a required grid comprising the electron gun is comprised of the grid plates each having the beam apertures. At least one grid plate among the plurality of grid plates has a beam aperture with an aperture diameter of less than 80% or less of an overall pseudo plate thickness. When compared with the case of comprising the grid with one sheet of metal, it becomes possible to provide a beam aperture with a small diameter.

### BACKGROUND OF THE INVENTION

1. Field of the Invention

The present invention relates to an electron gun used in a cathode-ray tube.

2. Description of the Related Art

FIG. 1 shows one example of grid arrangement of an electron gun. This electron gun 1 is comprised of three cathodes K (K_{R}, K_{G}, K_{B}) arranged in an inline fashion, and a plurality of grid electrodes arranged to be in common with each of the cathodes K_{R}, K_{G}, K_{B}. The three cathodes K (K_{R}, K_{G}, K_{B}) are used for displaying red, green and blue, respectively. These grid electrodes include a first grid G₁, a second grid G₂, a third A grid G_{3A}, a third B grid G_{3B}, a fourth grid G₄, a fifth A grid G_{5A}, a fifth B grid G_{5B}, an intermediate grid G_{M}, and a sixth grid G₆. A shield cup G₇ is integrally provided on the end of the sixth grid G₆.

A lead wire 3 is connected to the first grid G₁. A lead wire 4 is connected to the second grid G₂ and the fourth grid G₄. Namely, the second grid G₂ and the fourth grid G₄ are electrically connected to each other. A lead wire 6 is connected to the third A grid G_{3A} and the fifth B grid G_{5B}. Namely, the third A grid G_{3A} and the fifth B grid G_{5B} are electrically connected to each other. In addition, a lead wire 5 is connected to the third B grid G_{3B} and the fifth A grid G_{5A}. Namely the third B grid G_{3B} and the fifth A grid G_{5A} are electrically connected to each other.

A predetermined voltage is respectively applied to the grids G₁, G₂, G₃, G₄ and G₅. through each lead wire. In other words, a predetermined low voltage is applied to the first grid G₁. In addition, a predetermined low voltage is applied to the second grid G₂ and the fourth grid G₄. A predetermined focus voltage Fc is applied to the third B grid G_{3B} and the fifth A grid G_{5A}. A dynamic focus voltage Fv is applied to the third A grid G_{3A} and the fifth B grid G_{5B}. An anode voltage VH is applied to the sixth grid G₆ and the shield cup G₇. The anode voltage VH is applied to the sixth grid G₆ and the shield cup G₇. Further, the voltage V_{M} is applied to the intermediate grid G_{M}. The voltage V_{M} has an intermediate voltage between the anode voltage VH and the focus voltage Fv. In FIG. 1 the voltage VH is obtained by dividing the anode voltage VH through an internal resistance board 7.

The shield cup G₇ is formed in a cylindrical shape. Three beam apertures which correspond to each of the three cathodes K (K_{R}, K_{G}, K_{B}) are formed in the first grid G₁, the second grid G₂, the third A grid G_{3A}, the third B grid G_{3B}, the fourth grid G₄, the fifth A grid G_{5A}, the fifth B grid G_{5B} and the sixth grid G₆.

The triple-pole portion 8 of the electron gun 1 is formed of the cathode K (K_{R}, K_{G}, K_{B}), a second grid G₂ that draws the electron beam from the cathode K, and a first grid G₁ that enters between the cathode K and the second grid G₂ to thereby restrict the electron beam by an electric field therebetween.

Normally, the material used for the grid assembly that comprises the electron gun is a metal. The grid assembly is manufactured by means of a press process technique. For example, because a beam aperture is formed in a metal plate by a punch process, it can be formed with good accuracy.

Recently, however, requests to reduce the electron beam spot diameter on fluorescent surfaces even further have been increasing following the higher precision of color cathode-ray tubes used for, for example, displays. Consequently, in the three-pole portion of the electron gun even more reductions have been requested in the beam aperture diameters of the grids. concretely, there is a growing demand that the beam apertures of the first grid G₁ and the second grid G₂ be reduced. This made it necessary to form beam apertures with smaller diameters without using thick plates for the metal plates.

For the diameters of conventional beam apertures, however, aperture diameters that occupied approximately 80% of the metal plate were limits. That was because there was a need to maintain the durability of the punch die.

In other words, as shown in FIG. 2, a beam aperture 14 is formed in the metal plate 11 using round or elliptical punch die (12, 13). Hereupon, the plate thickness T₁ of the beam aperture portion and the aperture diameter ΦD of the beam aperture 14 are decisive factors in determining the basic characteristics of an electron gun as well as extremely important dimensions. In current punch process technology, however, aperture diameters that occupy 80% or less of the metal plate thickness T₁ have not been realized from the perspective of durability of the punch die (12, 13).

Because of this, conventional beam apertures formed in grids of electron guns did not have much degree of freedom in the design because the beam diameter ΦD had the relationship ΦD≧0.8T₁ for the thickness T₁.

If the plate thickness T₁ is made thinner, the aperture diameter can proportionately-be reduced in size. But electric fields permeate particularly the second grid G₂ from the first grid G₁ and the third grid G₃. For this reason the thickness T₁ of the beam aperture of the second grid G₂ is in need of a required thickness according to the demand of the characteristics. Therefore, there were also limits on the plate thickness being made thinner.

Furthermore, as shown in FIG. 3, there is a case in which coining 15 is applied to the beam apertures corresponding to the red, green and blue of the second grid G₂. A thickness T₀ in FIG. 3 is a plate thickness of the coining portion. The coining 15 is applied to the second grid G₂ in order to form an astigmatic electric field lens or the like. For the degree of freedom in the design of the grid to improve, it is desirable that separate voltages be applied to the beam aperture 14 portion and the coining 15 portion. However, in the structure shown in FIG. 3, it is impossible to apply separate voltages to the beam aperture 14 portion and the coining 15 portion.

### SUMMARY OF THE INVENTION

The present invention is an electron gun for a cathode-ray tube comprised of a plurality of grids and of the grids a required grid is comprised of a plurality grid plates each having an beam aperture. At least one grid plate among the plurality of grid plates has a beam aperture with an aperture diameter of 80% or less of a pseudo plate thickness formed of the plurality of grid plates.

The electron gun according to the present invention is such that a required grid constituting the electron gun is comprised of the plurality of grid plates. Therefore, since it is possible to make the thickness of each grid plate thinner, it becomes possible to form the beam aperture with a small diameter as well as make a pseudo plate thickness of the grid necessary for the characteristics thereof. Since it becomes possible to form the beam aperture with a small diameter, formation of a plurality of beam apertures corresponding to each cathode becomes possible, thereby increasing the degree of freedom in the design of the electron gun. In addition, since the required grid is comprised of the plurality of grid plates, it becomes possible that an electric potential difference is held within the grid and a dynamic electric potential is applied to the grid plates making it possible to change the shape of the beam apertures in the grid plates. Namely, since it becomes possible to form an astigmatic electric field lens, to control the path of the electron beam and so on, the degree of freedom in the design of the electron gun is increased. Consequently, by means of providing the electron gun of the present invention it becomes possible to offer a cathode-ray tube of high performance.

Moreover, the electron gun according to the present invention is such that the second grid thereof is comprised of a plurality of grid plates.

The electron gun of the present invention is such that the second grid thereof is comprised of the plurality of grid plates. Therefore, since the thickness of each grid can be made smaller, it becomes possible to form the beam aperture with a small diameter.

From the standpoint of the characteristics of the electron gun, the second grid needs to have a predetermined thickness. According to the present invention, the thickness of the second grid becomes an overall pseudo plate thickness formed of a plurality of grid plates. Consequently, it becomes possible to secure a required plate thickness necessary for the characteristics of the electron gun. In the second grid it becomes possible to form a beam aperture with an aperture diameter which is smaller than the press process limit with respect to the overall pseudo plate thickness, that is, 80% or less of the required thickness. Consequently, for the electron gun it becomes possible to realize a three-pole portion having a beam aperture with a small diameter, which has been unable to realize.

According to the present invention, since it becomes possible to form a beam aperture with a small diameter in the second grid, formation of a plurality of beam apertures corresponding to each cathode becomes easier, thereby increasing the degree of freedom in the design of the electron gun.

In addition, since the required grid is comprised of a plurality of grid plates, it becomes possible that an electric potential difference is held within the grid and a dynamic electric potential is applied to the grid plates making it possible to change the shape of the beam apertures in the grid plates. Namely, since it becomes possible to form an astigmatic electric field lens, and to control the path of the electron beam and so on, the degree of freedom in the design of the electron gun is increased.

Consequently, by means of providing the electron gun of the present invention it becomes possible to offer a cathode-ray tube of high performance.

The present invention is suitable for being applied to, for example, the second grid and can realize a three-pole portion having a very small beam aperture which has conventionally been unable to be realized due to the limit on the plate thickness.

### BRIEF DESCRIPTION OF THE DRAWINGS

FIG. 1 is a diagram showing one example of the configuration of a conventional electron gun as well as explaining a layout and electrical connections of each grid;

FIG. 2 is a diagram showing the method of how to make an aperture in a metal plate using a punch die as the method of forming a beam aperture;

FIG. 3 is a diagram explaining an example of the structure in the vicinity of a beam aperture of a second grid comprised of one sheet of metal as well as explaining the structure in which a coining process is applied in the vicinity thereof;

FIG. 4 is a diagram showing one embodiment of an electron gun according to the present invention as well as explaining the layout and electrical connections of a grid when a second grid is comprised of a plurality of grid plates;

FIG. 5 is a diagram showing a cross-sectional view of an essential portion in the vicinity of a beam aperture as one example of a second grid according to the present invention as well as the state in which the second grid is comprised of two grid plates and beam apertures are provided in the grids, respectively;

FIG. 6 is a diagram showing a cross-sectional view of an essential portion in the vicinity of a beam aperture as an another example of a second grid according to the present invention as well as the state in which the second grid is comprised of two sheets of grids and beam apertures with different diameters are provided in the grids, respectively;

FIG. 7A is a diagram showing a further another example of the shape of a beam aperture used in the second grid according to the present invention, wherein a grid aperture of a grid plate G_{2A} is made laterally long in shape in the horizontal, that is, left and right direction of FIG. 4 and an aperture of a grid plate G_{2B} is made circular in shape;

FIG. 7B is a diagram showing a still further another example of the shape of a beam aperture used in the second grid according to the present invention, wherein a grid aperture of the grid plate G_{2A} is longitudinally long in shape in the vertical, that is, vertical direction with respect to the paper surface of FIG. 4 and the aperture of the grid plate G_{2B} is made circular in shape;

FIG. 7D is a diagram showing a still further another example of the shape of a beam aperture used in the second grid according to the present invention, wherein the beam aperture of the grid plate G_{2A} is made the shape of a large circle and the beam aperture of the grid plate G_{2B} is made the shape of a small circle;

FIG. 8 is a diagram showing a cross-sectional view of an essential portion in the vicinity of a beam aperture as a further another example of the second grid according to the present invention, wherein the second grid is comprised of three sheets of grid plates and beam apertures are provided in the grid plates, respectively;

FIG. 9 is a diagram showing a cross-sectional view of an essential portion in the vicinity of a beam aperture of a conventional second grid in order to compare with the present invention;

FIG. 10 is a diagram showing a cross-sectional view of an essential portion in the vicinity of a second grid to be explained in an embodiment 1; and

FIG. 11 is a diagram showing a cross-sectional view of an essential portion in the vicinity of a second grid to be explained in an embodiment 2.

### DESCRIPTION OF THE PREFERRED EMBODIMENTS

In the following embodiments of the present invention will be described while referring to the drawings.

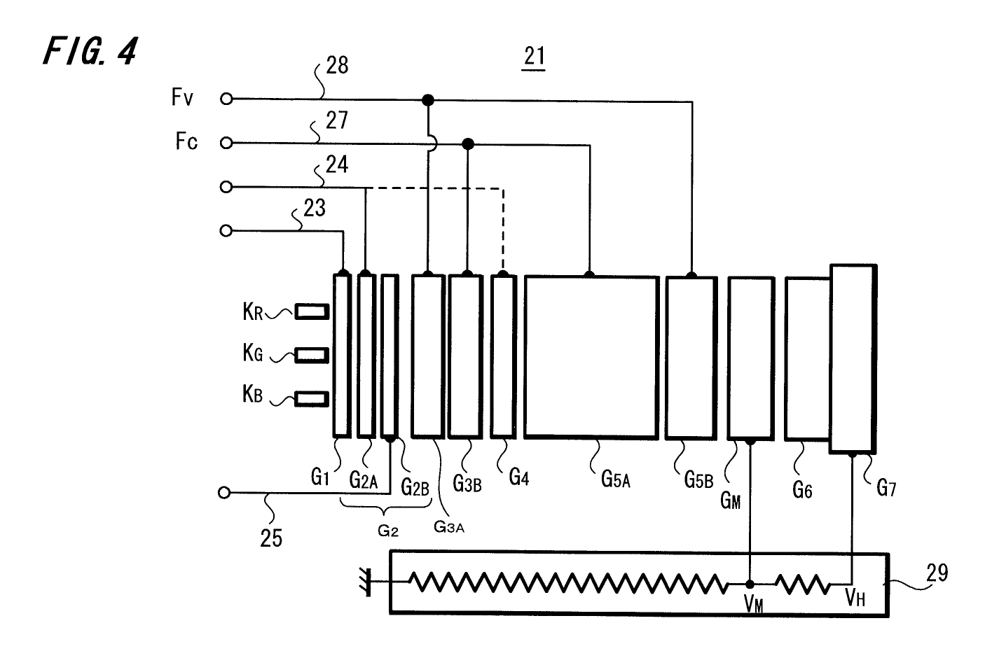

FIG. 4 shows an embodiment of the electron gun of the present invention. The electron gun shows an electron gun as applied to an inline electron gun as previously described. The electron gun 21 is comprised of three cathodes K (K_{R}, K_{G}, K_{B}) arranged in an inline fashion, and a plurality of grid electrodes arranged to be in common with each of the cathodes K_{R}, K_{G}, K_{B}. The three cathodes K (K_{R}, K_{G}, K_{B}) are used for displaying red, green and blue, respectively. These plurality of grids are, for example, a first grid G₁, a second grid G₂ (described later), a third A grid G_{3A}, a third B grid G_{3B}, a fourth grid G₄, a fifth A grid G_{5A}, a fifth B grid G_{5B}, an intermediate grid G_{M}, and a sixth grid G₆. A cylindrical shield cup G₇ is integrally provided on the end of the sixth grid G₆.

Three beam apertures which correspond to the three cathodes K (K_{R}, K_{G}, K_{B}) are formed in each of the first grid G₁, the second grid G₂, the third A grid G_{3A}, the third B grid G_{3B}, the fourth grid G₄, the fifth A grid G_{5A}, the fifth B grid G_{5B}. the intermediate grid G_{M} and the sixth grid G₆. Each of these grids G₁˜G₆ and the shield cup G₇ are maintained at required distance and secured by a pair of bead glass.

A lead wire 23 is connected to the first grid G₁. Connections of the second grid G₂ and the fourth grid G₄ will be described later. A lead wire 27 is connected to the third B grid G_{3B} and the fifth A grid G_{5A}. That is, the third B grid G_{3B} and the fifth A grid G_{5A} are connected to each other. A lead wire 28 is connected to the third A grid G_{3A} and the fifth B grid G_{5B}. That is, the third A grid G_{3A} and the fifth B grid G_{5B} are connected to each other.

A predetermined voltage is applied to each grid G₁, G₂, G₃, G_{3A}, G_{3B}, G₄, G_{5A} and G_{5B} through each lead wire. That is, a predetermined low voltage is applied to the first grid G₁. A predetermined low voltage is applied to the second grid G₂, which will be described later. In addition, a predetermined low voltage is applied to the fourth grid G₄, which is to be described later on. A predetermined focus voltage F_{C} is applied to the third B grid G_{3B} and the fifth A grid G_{5A}. A dynamic focus voltage Fv is applied to the third A grid G_{3A} and the fifth B grid G_{5B}. An anode voltage VH is applied to the sixth grid G₆ and the shield cup G₇. A voltage V_{M} is applied to the intermediate grid G_{M}. The voltage V_{M} has an intermediate voltage between the anode voltage VH and the focus voltage Fv. The voltage V_{M} is applied to the sixth grid G₆ and the shield cup G₇ through an internal resistance board 29.

In this embodiment in particular, the second grid G₂ is comprised of a plurality of grid plates. In this example the second grid G₂ is comprised of two grid plates G_{2A} and G_{2B}. The two grid plates G_{2A} and G_{2B} are arranged in series in the direction the electron beam progresses.

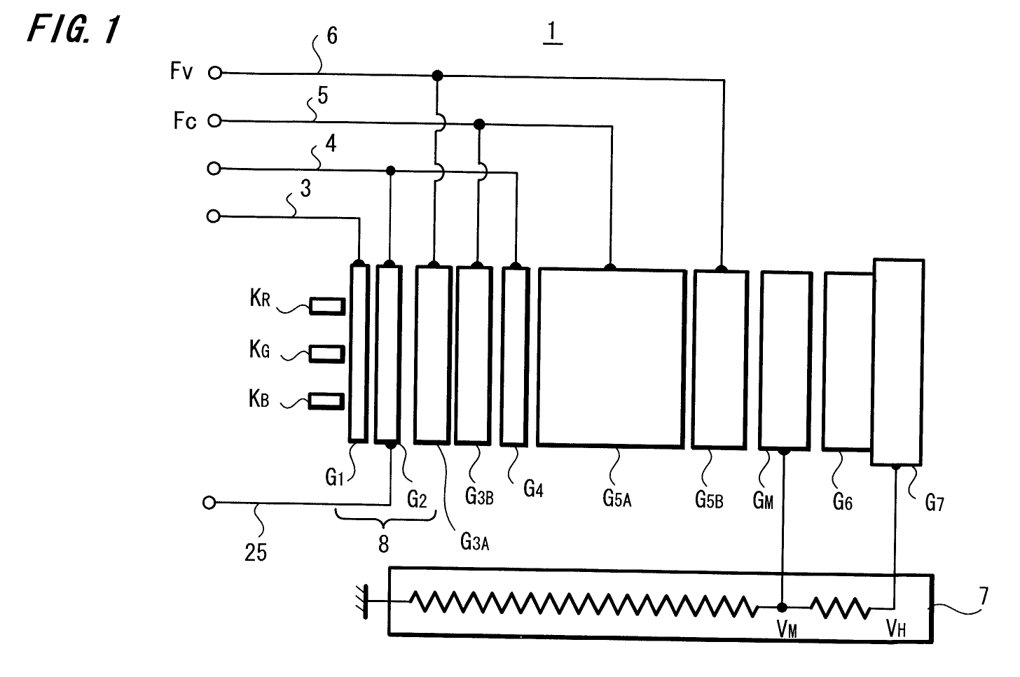

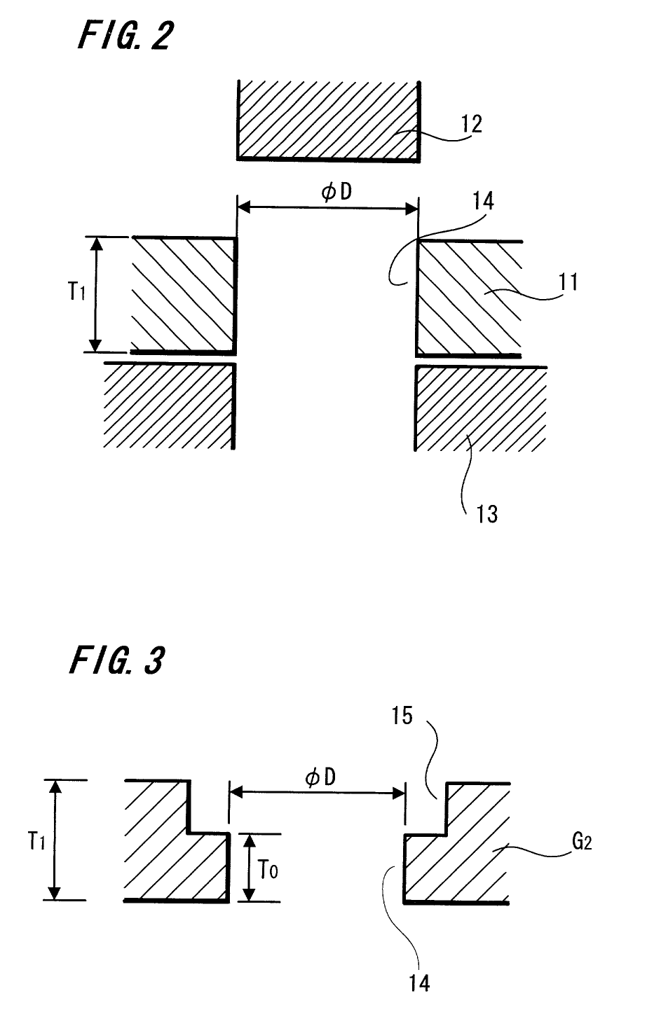

The lead wire connection and the supply of the electric potential for the two grid plates G_{2A} and G_{2B} that comprise the second grid G₂ can be obtained in various ways depending on the design of the electron gun. In the example of FIG. 4, the lead wire 24 and the lead wire 25 are independently connected to the grid plates G_{2A} and G_{2B}, respectively. With these two grid plates G_{2A} and G_{2B}, a predetermined low voltage is applied to at least the grid plate G_{2A}. Various kinds of voltage to be applied to the grid plate G_{2B} can be set as described later on. For example, for cases such as when a static voltage is applied to the grid plate G_{2B} in a like manner to the grid plate G_{2A}, or when a static voltage is applied to the grid plate G_{2B} in a manner different from the grid plate G_{2A}, or when a voltage that changes dynamically (dynamic voltage) is applied to the grid plate G_{2B}, various settings can be made as described later. Moreover, various kinds of voltages applied to the fourth grid G₄ can be set. For example, for cases such as when a voltage to be applied to the fourth grid G₄ is a predetermined voltage through an independent lead wire or, as shown by the dashed lines in FIG. 1, when the fourth grid G₄ and the grid plate G_{2A} are connected in common and a voltage is applied in a like manner to the grid plate G_{2A}, various settings can be made.

As shown in, for example, FIG. 5, the two grid plates G_{2A} and G_{2B} that comprise the second grid G₂ are made such that a coining process is used to form both of two metal plates 17, 18 (which has a required thickness) into a suitable shape. In an example shown in FIG. 5, the plate thickness Tₐ, T_{b} of the coining portions 17a, 18a of both metal plates 17, 18 are processed thinner than a desired beam aperture diameter ΦD, for example, 80% or less of the beam aperture diameter, and next, a beam aperture 19 is simultaneously or separately formed by means of a punch process. With the second grid G₂, an overall pseudo plate thickness T₂ (namely, the thickness between the end of the beam aperture on the first grid G₁ side and the end of the beam aperture on the third A grid G_{3A} side) that combines the two grid plates G_{2A} and G_{2B} forms an effective plate thickness for the second grid G₂. As the result, the second grid G₂ is formed having an aperture diameter Φd smaller than the press process limit with respect to the overall pseudo plate thickness. For example, 80% or less of the pseudo plate thickness T₂.

The two grid plates G_{2A} and G_{2B} can also be integrally fused together before the electron gun is assembled. Further, the two grid plates G_{2A} and G_{2B} can also be independently secured by bead glass or electrically insulated and secured to another structure. A static electric potential can also be applied to these two grid plates G_{2A} and G_{2B} in a like manner to the conventional second grid G₂. The first grid G₁ is a grid for a cut-off. The third A grid G_{3A} is a grid for forming an electrical field such as an astigmatic electric field lens and the like. Different static electric potentials can also be applied to the grid plate G_{2A} on the first grid G₁ side and to the grid plate G_{2B} on the third A grid G_{3A} side. In other words, different static electric potentials can be applied in order to generate an electric potential difference between the grid plates G_{2A} and G_{2B}. Further, not only can a static electric potential be applied to at least the grid plate G_{2A} on the first grid G₁ side but an electric potential and a dynamic electric potential as well can also be applied to the grid plate G_{2B} on the third A grid G_{3A} side. Even further, a dynamic electric potential can also be applied to both the grid plates G_{2A} and G_{2B} in order to generate an electric potential difference between both of the grid plates G_{2A} and G_{2B}.

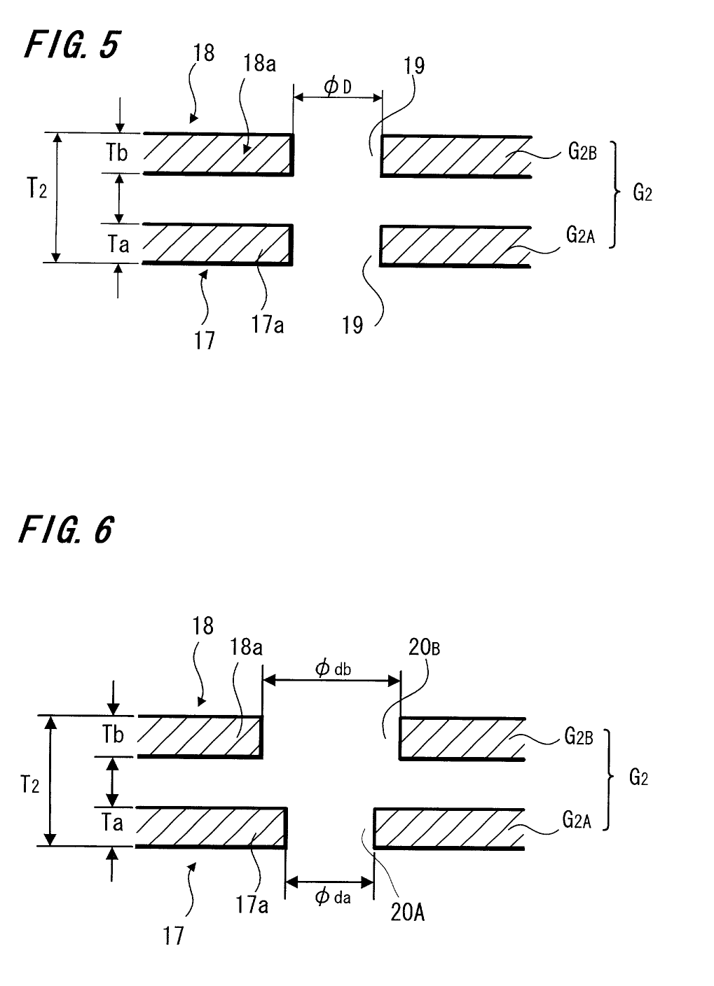

FIG. 6 shows another example of the second grid G₂ comprised of the two grid plates G_{2A} and G_{2B}. The grid plates G_{2A} and G_{2B} are formed with different beam aperture diameters for respective beam apertures which correspond to red, green and blue. In other words, the beam aperture 20A with an aperture diameter Φda is formed in the grid plate G_{2A} on the first grid G₁ side and the beam aperture 20B with an aperture diameter Φdb (larger than aperture diameter Φda) is formed in the grid plate G_{2B} on the third A grid G_{3A} side. Other compositions are identical to FIG. 5. The aperture 20B of the grid plate G_{2A} does not need to be round.

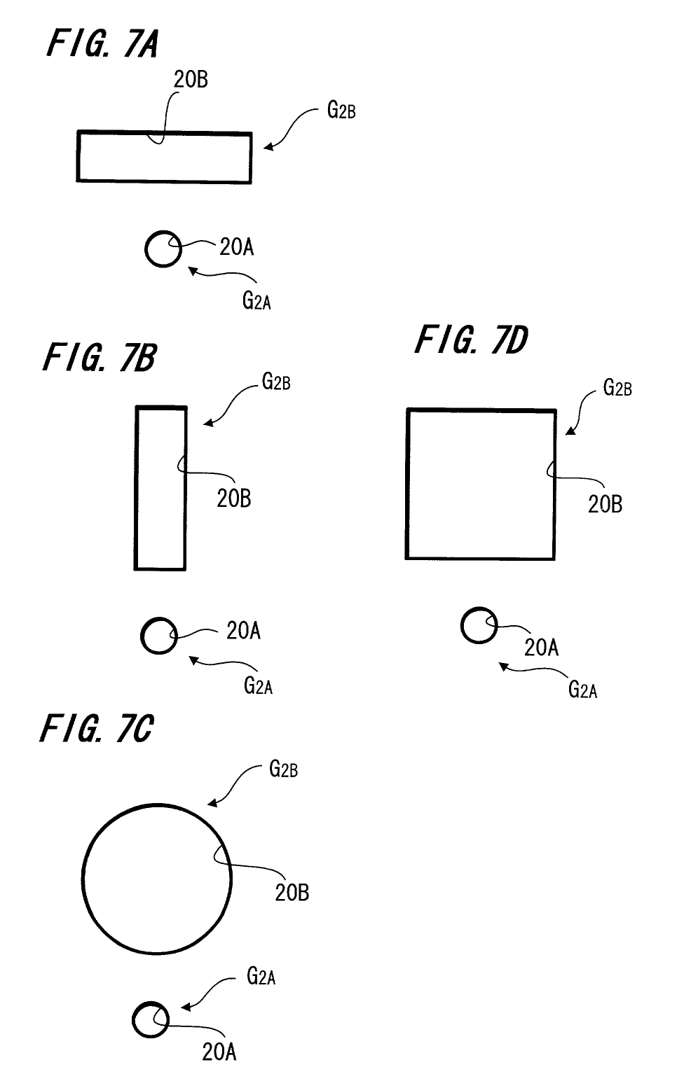

FIGS. 7A-7D show examples of shapes for 20A and 20B. FIG. 7A shows the beam aperture of the grid plate G_{2A} formed in a circular shape and the beam aperture of the grid plate G_{2B} formed in a horizontally long rectangular shape. FIG. 7B shows the beam aperture of the grid plate G_{2A} formed in a circular shape and the beam aperture of the grid plate G_{2B} formed in a vertically long rectangular shape. FIG. 7C shows the beam aperture of the grid plate G_{2A} formed in a circular shape and the beam aperture of the grid plate G_{2B} formed in a circular shape. FIG. 7D shows the beam aperture of the grid plate G_{2A} formed in a circular shape and the beam aperture of the grid plate G_{2B} formed in a square shape.

In this embodiment, of the two grid plates G_{2A} and G_{2B} the beam aperture diameter or shape of the beam aperture 20A of the grid plate G_{2A} and the beam aperture 20B of the grid plate G_{2B} on the third A grid G_{3A} side is made different, for example, as shown in FIGS. 7A˜7D, thereby making it possible to form an astigmatic electrical field lens. As the result, the shape of electron beams can be altered. Provision of the beam aperture 20B of the grid plate G_{2A} by shifting the center thereof with respect to that of the beam aperture 20B of the grid plate G_{2A} can control the beam path. Further, of the two grid plates G_{2A} and G_{2B}, by applying a dynamic voltage to the grid plate G_{2B} on the third A grid G_{3A} side to thereby change the beam shape by forming a separate electric field such as an astigmatic electric field, the beam path can be controlled. In addition, the beam aperture of the grid plate G_{2A} is not limited to only a circular shape but can also be, for example, a square shape. A plurality of apertures can also be provided in the grid plate G_{2A} for a cathode. For this case, the orientation of the plurality of apertures is not limited to a particular direction. For example, the plurality of apertures can be arranged lined up in the horizontal, that is, the orientation direction of the three cathodes with respect to one cathode. A plurality of beam apertures can also be arranged in the vertical direction or in the horizontal as well as vertical direction with respect to one cathode. Even further, they can be radially arranged with respect to one cathode.

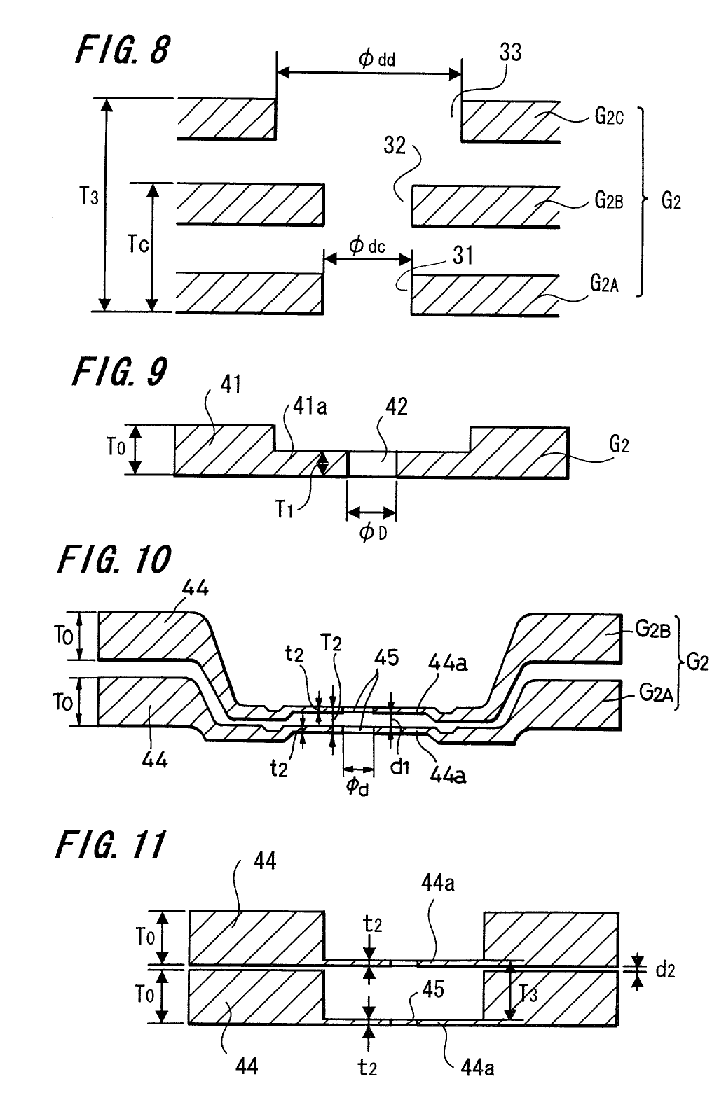

FIG. 8 shows another example of the second grid G₂ related to this embodiment. This second grid G₂ is comprised of three grid plates G_{2A}, G_{2B} and G_{2C}. The aperture diameters and shapes of beam apertures 31, 32 and 33 formed in each of these grid plates G_{2A}, G_{2B} and G_{2C} can be formed identically or differently. In the example in this figure, the beam apertures 31, 32 with identical aperture diameters Φdc are formed in the two grid plates G_{2A} and G_{2B} on the first grid G₁ side. The beam aperture 33 with an aperture diameter Φdd larger than the beam apertures 31, 32 is formed in the grid plate G_{2C} on the third A grid G_{3A} side. The shapes of the beam apertures 31, 32 and the shape of the beam aperture 33 can have the relationship shown in, for example, FIGS. 7A˜7D. In the example in this figure, the diameter of the beam apertures 31, 32 can be formed at 80% or less of the pseudo plate thickness Tc formed of the two grid plates G_{2A} and G_{2B}. Thickness T₃ is an overall pseudo thickness of the three grid plates G_{2A}, G_{2B} and G_{2C}.

As for the electric potential to be applied, identical static electric potentials can be applied to the three grid plates G_{2A}, G_{2B} and G_{2C}. For an electric potential difference to be generated between arbitrary two among the three grid plates G_{2A}, G_{2B} and G_{2C}, different static electric potentials or a dynamic electric potential can also be applied to the grid plates. A static electric potential can be applied to the grid plate G_{2A} on the first grid G₁ side and then a dynamic electric potential may be applied to any of the remaining grid plates. For example, a static electric potential can be applied to the grid plates G_{2A} and G_{2B} and a dynamic electric potential can be applied to the grid plate G_{2C}. In addition, a static electric potential can be applied to the grid plate G_{2A} and a dynamic electric potential can be applied to the grid plates G_{2B} and G_{2C}.

An astigmatic electric field or the beam path can be controlled in a like manner to the example above by means of selecting the beam aperture shape or shapes of the three grid plates G_{2A}, G_{2B} and G_{2C} and the grid plate or plates where a dynamic electric potential or potentials will be applied.

By means of providing the electron gun described above in this embodiment, color cathode-ray tubes used in display devices such as, for example, color displays can be constituted.

According to the embodiment described above, by means of constituting the second grid G₂ with a plurality of grid plates, it is possible to obtain a second grid G₂ with a smaller beam aperture compared to when a second grid G₂ is formed of a single metal plate. An aperture diameter smaller than the press process limit with respect to the effective thickness for the second grid G₂, or what is called the pseudo thickness, for example, a diameter of 80% or less of the pseudo thickness can be formed. Consequently, a triple-pole structural portion could be achieved that has very small beam apertures which had conventionally been unable to be achieved due to restrictions on the plate thickness. In addition, Because of these characteristics, a second grid G₂ having very small beam apertures can be constituted through the use of a required and sufficient, namely, optimum plate thickness. Further, a plurality of beam apertures can be provided for each cathode.

Since the second grid G₂ can be comprised of a plurality of grid plates, for example, two, three or more grid plates, not only a single electric potential can be applied to these grid plates but a separate electric potential or a dynamic voltage can also be applied to each grid plate. Consequently, a cathode-ray tube with even higher performance can be provided through the use of the electron gun of this embodiment. Furthermore, the beam apertures of the grid plates G_{2A} and G_{2B} are not limited to only a circular shape but can also be, for example, a square shape. Even further, although a description about the beam apertures of the grid plates G_{2A}, G_{2B} and G_{2C} arranged on the same axis was provided, the arrangement is not limited to the same axis. For example, these beam apertures can be arranged eccentrically. By means of arranging the beam apertures eccentrically, the electric field will be asymmetric. Therefore, the path of the electron beam can be bent in response to the amount of the eccentricity. In addition, a plurality of apertures can also be provided for the grid plates G_{2A} and G_{2B}. For this case, the orientation of the plurality of apertures is not limited to a particular direction. For example, the plurality of apertures can be arranged in the horizontal direction, namely, in the direction the three cathodes are arranged. Further, they can also be arranged in the vertical direction or the horizontal direction. Even further, they can be arranged radially as well.

Using a plurality of grid plates as described above is not limited to the second grid G₂ but can also be applied to other grids comprising an electron gun. A single electric potential, separate electric potentials or a dynamic voltage can be applied to these grids. In addition, the present invention is not limited to the electron gun shown in FIG. 4 but can also be applied to electron guns which utilize other formats.

According to the present invention, a plurality of beam apertures can be provided for each cathode. Therefore, the present invention is suitably applied to a cathode-ray tube which displays a monochromatic image by using a plurality of electron beams, that is, multi-beam cathode-ray tube. Further, by means of making eccentric respective beam apertures for the plurality of grid plates comprising the second grid G₂, the curvature of the path of the electron beam can be adjusted. Consequently, the present invention is also suited for use in electron guns used for multi-beam format cathode-ray tubes which require a plurality of electron beams for each color to be converged on a fluorescent surface.

[Embodiments]

<Embodiment 1>

FIG. 9 shows a structure of the conventional second grid G₂ in order to compare with the present invention. For this second grid G₂, a metal plate 41 with a plate thickness Tₒ of 0.4 mm undergoes a coining process to obtain a plate thickness T₁ of 0.2 mm at the coining portion. Thereafter, an beam aperture 42 with an aperture diameter ΦD of 0.16 mm is formed at the coining portion 41a. This aperture diameter is the punch process limit, that is, 80% of the plate thickness.

FIG. 10 shows an embodiment of a second grid G₂ related to the present invention. For the second grid G₂ of this example, a metal plate 44 with a plate thickness Tₒ of 0.4 mm undergoes a coining process to obtain a plate thickness t₂ of 0.05 mm at the coining portion. Thereafter, a beam aperture 45 with an aperture diameter Φd of 0.04 mm is formed at a coining portion 44a of the grid plate. This aperture diameter is the punch process limit, that is, 80% of the plate thickness. The second grid G₂ of this embodiment is comprised of above processed two grid plates G_{2A} and G_{2B} being arranged at an interval d₁ of 0.1 mm. The beam aperture diameter Φd (0.04 mm) is 20% of the coining portion pseudo plate thickness T₂ (0.2 mm). According to this embodiment, it is possible to obtain a second grid G₂ that has an effective plate thickness T₂ identical to the conventional plate thickness T₁ (t₂+t₂+d₁=T₁) and a very small beam aperture 45 with an aperture diameter of 80% or less with respect to the plate thickness.

<Embodiment 2>

FIG. 11 shows another embodiment of the second grid G₂ according to the present invention. The grid plate G₂ according to this embodiment is such that a metal plate 44 with a plate thickness T₀ of 0.4 mm undergoes a coining process to obtain a plate thickness t₂ of 0.05 mm at the coining portion. Thereafter, a beam aperture 45 with an aperture diameter Φd of 0.04 mm is formed in the coining portion. This aperture diameter is the punch process limit, that is, 80% of the plate thickness. The grid plate G₂ is comprised of above processed two grid plates G_{2A} and G_{2B} being arranged at an interval of 0.05 mm. The beam aperture diameter (0.04 mm) is 8% of the coining portion pseudo plate thickness T₃ (0.5 mm). According to the second grid G₂ of this embodiment example, a pseudo plate thickness T₃ having a very small beam aperture can be made thicker as well.

Having described preferred embodiments of the present invention with reference to the accompanying drawings, it is to be understood that the present invention is not limited to the above-mentioned embodiments and that various changes and modifications can be effected therein by one skilled in the art without departing from the spirit or scope of the present invention as defined in the appended claims.

What is claimed is:

1. An electron gun being comprised of a plurality of grids, wherein
a required grid among said grids is formed of a plurality of grid plates each having a beam aperture and at least one grid plate among said plurality of grid plates has an aperture diameter of less than 80% with respect to an overall pseudo plate thickness formed of said plurality of grid plates.

2. An electron gun as set forth in claim 1, wherein an identical static electric potential is applied to said plurality of grid plates.

3. An electron gun as set forth in claim 1, wherein a different static electric potential is applied to said plurality of grid plates in order to generate an electric potential difference between arbitrary grid plates.

4. An electron gun as set forth in claim 1, wherein a static electric potential and a dynamic electric potential are selectively applied to said plurality of grid plates of said grid.

5. An electron gun as set forth in claim 1, wherein a dynamic electric potential is applied to said plurality of grid plates.

6. An electron gun as set forth in claim 1, wherein beam apertures formed in the plurality of grid plates have identical shapes or different shapes.

7. An electron gun for a cathode-ray tube, being comprised of a plurality of grids, wherein
a second grid is formed of a plurality of grid plates each having a beam aperture.

8. An electron gun as set forth in claim 7, wherein at least one grid plate among said plurality of grid plates has an aperture diameter of 80% or less of the press process limit with respect to an overall pseudo plate thickness formed of said plurality of grid plates.

9. An electron gun as set forth in claim 7, wherein an identical static electric potential is applied to the plurality of grid plates of said second grid.

10. An electron gun as set forth in claim 7, wherein different static electric potentials are applied to the plurality of grid plates of said second grid in order to generate an electric potential difference among arbitrary grid plates.

11. An electron gun as set forth in claim 7, wherein a static electric potential is applied to an grid plate on a first grid side among the plurality of grid plates of said second grid and a dynamic electric potential is applied to any of the remaining grid plates.

12. An electron gun as set forth in claim 7, wherein a dynamic electric potential is applied to the plurality of grid plates of said second grid.

13. An electron gun as set forth in claim 7, wherein beam apertures formed in the plurality of grid plates of said second grid have identical shapes or different shapes.
